(19) United States
(12) Patent Application Publication
(10) Pub. No.: US 2022/0297405 A1
(43) Pub. Date: Sep. 22, 2022

(54) ENVELOPE LINER TEMPLATE

(71) Applicant: Jennifer Ann JACOBELLIS, Santa Rosa, CA (US)

(72) Inventor: Jennifer Ann JACOBELLIS, Santa Rosa, CA (US)

(21) Appl. No.: 17/205,999

(22) Filed: Mar. 18, 2021

(51) Int. Cl. B31B 70/81; B65D 27/00; B31B 70/20; B31B 70/99

(52) U.S. Cl. CPC B31B 70/81; B65D 27/005; B31B 70/20; B31B 70/99; B31B 2160/10

(57) ABSTRACT

An envelope liner template having a first panel having a pattern inscribed therein and a second panel. The second panel is positioned below the first template and attached by a fastening mechanism. The fastening mechanism is adapted to secure a decorative sheet in place between the first panel and the second panel when a cutting implement cuts through the pattern and the sheet against the second template panel to form an envelope liner.

### TECHNICAL FIELD

The subject disclosure relates to a template for creating an envelope liner. More specifically, the template is a self-contained modular guide for creating a liner composed of one or more templates at a single time.

### BACKGROUND OF THE INVENTION

Envelopes liners are aesthetically pleasing and add a nice personal touch to an envelope for various occasions. However, designing, ordering and purchasing custom envelop liners is quite a lengthy and expensive endeavor. Tutorials for making envelop liners are tedious, time consuming and require various products. A low-cost method for making numerous envelop liners at a low cost simply is not available.

Formal invitations often include envelope liners as a way to add a decorative, and finished touch. Liners can be purchased as an add on to the envelopes but can be pricey when you are purchasing hundreds of envelopes. Cumbersome techniques exist for making liners using various monotonous instruments such as, scissor, cardboard, etc.

Thus, there is a need for an envelope liner template that is modular, quick to create one or more liners, easy to use and efficient.

### SUMMARY OF THE SUBJECT DISCLOSURE

The present subject disclosure presents a simplified summary of the subject disclosure in order to provide a basic understanding of some aspects thereof. This summary is not an extensive overview of the various embodiments of the subject disclosure. It is intended to neither identify key or critical elements of the subject disclosure nor delineate any scope thereof. The sole purpose of the subject summary is to present some concepts in a simplified form as a prelude to the more detailed description that is presented hereinafter.

While various aspects, features, or advantages of the subject disclosure are illustrated in reference to envelope liners, such aspects and features also can be exploited in various other templates for stenciling various other patterns, such as but not limited to numbers, alphabet, characters and/or other cut out designs.

To the accomplishment of the foregoing and related ends, the subject disclosure, then, comprises the features hereinafter fully described. The following description and the annexed drawings set forth in detail certain illustrative aspects of one or more embodiments of the disclosure. However, these aspects are indicative of but a few of the various ways in which the principles of the subject disclosure may be employed. Other aspects, advantages and novel features of the subject disclosure will become apparent from the following detailed description of various example embodiments of the subject disclosure when considered in conjunction with the drawings.

In one exemplary embodiment, the present subject disclosure is an envelope liner template. The envelope liner template has a first panel with a pattern inscribed therein, and a second panel. The second panel is positioned below the first template and attached by a fastening mechanism. The fastening mechanism is adapted to secure a sheet in place between the first panel and the second panel when a cutting implement cuts through the pattern and the sheet against the second template panel to form an envelope liner.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 is a front view of an envelope liner template according to this subject disclosure in an open position.

FIG. 2 is a front view of a second layer of the envelope liner template overlayed by an ornamental sheet with a first layer about to be positioned over the second layer.

FIG. 3 is a front view of a second layer of the envelope liner template overlayed by an ornamental sheet with a first layer layered over the sheet during a cutting process.

FIG. 4 is a front view of the liner being positioned within an envelope.

FIG. 5 is a front view of the liner positioned within and attached to the envelope.

FIG. 6 is an upper perspective view of a disconnected hinge mechanism.

FIG. 7 is a side view of the hinge mechanism in a disconnected position.

FIG. 8 is a side view of the hinge mechanism in a first inserted position.

FIG. 9 is a side view of the hinge mechanism in a beginning rotated position.

FIG. 10 is a side view of the hinge mechanism in a mid-position.

FIG. 11 is a side view of the hinge mechanism in a closed position over a decorative sheet.

FIG. 12 is a front view of an interlocking connection of a first layer.

FIG. 13 is a front view of the interlocking connection of various interconnected first layers interlocked adjacent to each other.

FIG. 14 is a front view of an interlocking connection of a second layer.

FIG. 15 is a front view of the interlocking connection of various interconnected second layers interlocked adjacent to each other.

FIG. 16 is a front view of a first panel illustrating patterns having overlapping channels.

FIG. 17 is a front view of a first panel illustrating patterns having nested and overlapping channels.

FIG. 18 is an upper perspective view of a projection alignment mechanism.

FIG. 19 is a side view of the projection alignment mechanism in a disconnected position.

FIG. 20 is a side view of the projection alignment mechanism in a use connected position over a decorative sheet.

### DETAILED DESCRIPTION

Particular embodiments of this subject disclosure will now be described in greater detail with reference to the figures.

The subject disclosure is described with reference to the drawings, wherein like reference numerals are used to refer to like elements throughout. In the following description, for purposes of explanation, numerous specific details are set forth in order to provide a thorough understanding of the present disclosure. It may be evident, however, that the present disclosure may be practiced without these specific details.

An envelope liner compliments an envelope message by adding a personalized decorative flair to an envelope for various occasions, such as a greeting card, a birthday card, a wedding invitation, or other written announcement to a social event. The added liner adds an aesthetically pleasing customization to the presentation of the invitation while increasing the weight and quality of the envelope.

Various exemplary embodiments of the subject disclosure are presented throughout the figures. Multiple perspective views of an envelope template liner assembly according to an exemplary embodiment of the present subject disclosure are presented in various embodiments.

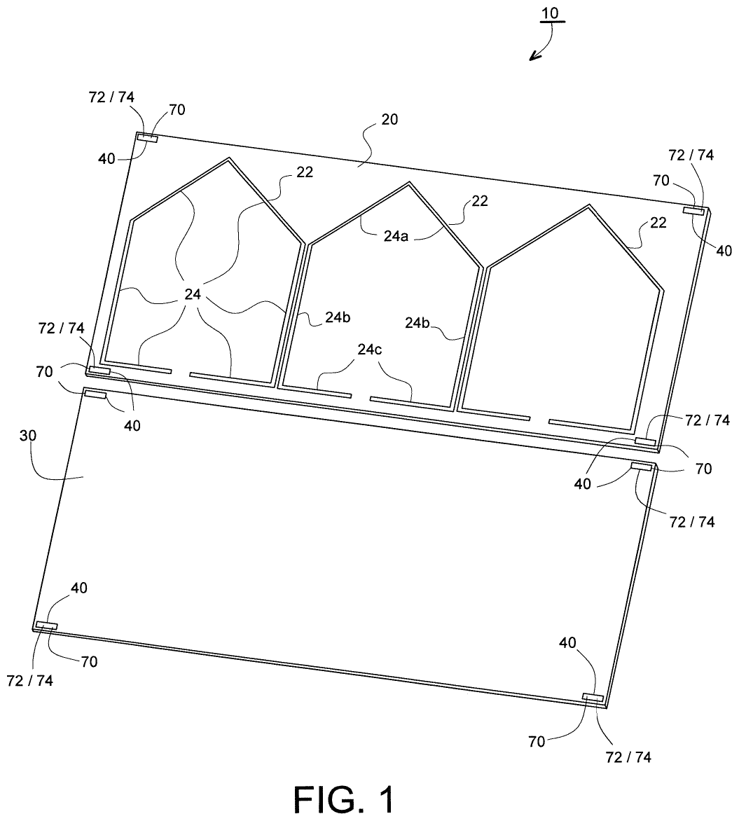

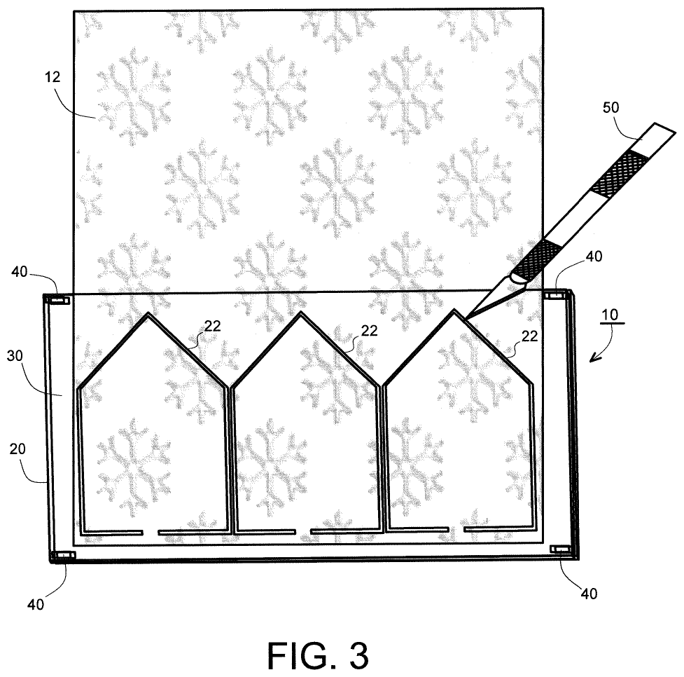

FIG. 1 shows an envelope liner template 10 according to the present subject disclosure. The envelope liner template 10 has a first layer 20 with at least one pattern 22, and a second layer 30 to back a cutting implement 50 (FIG. 3) being cut through the pattern 22. The first layer 20 may be connected to the second layer 30 at a fastener mechanism 40.

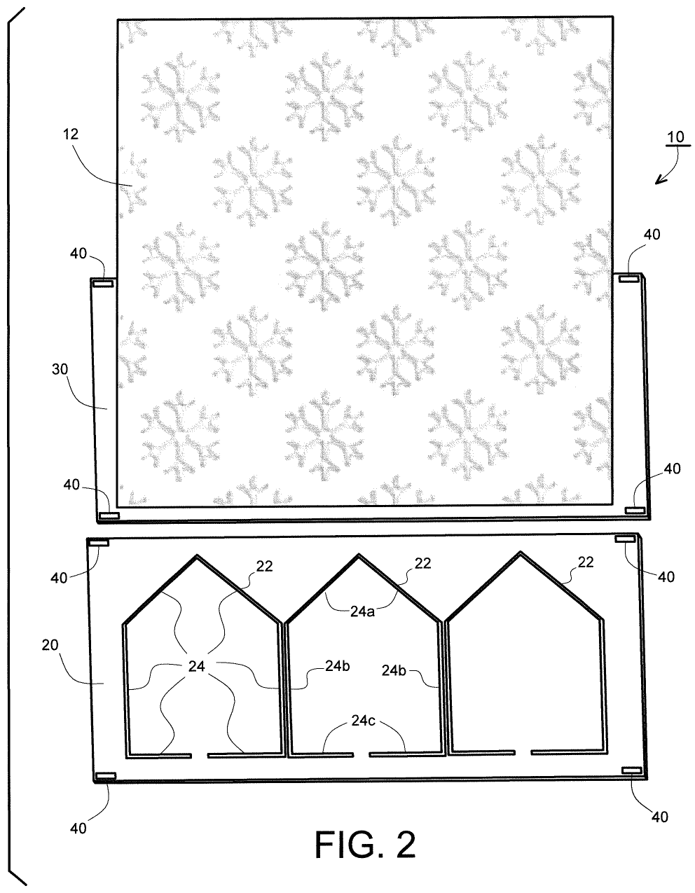

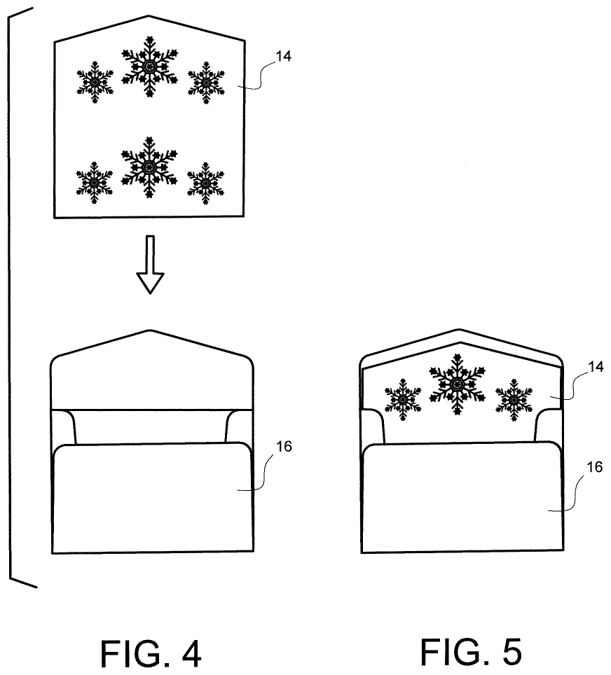

FIGS. 2-3 show the first layer 20 or first template panel has the pattern 22 inscribed therein for receiving the cutting implement 50. The pattern 22 is made up of various narrow channels 24 in the shape of an envelope liner 14 (FIGS. 4-5). A width of the various narrow channels 24 may be slightly larger than the width of a sharp cutting edge of the cutting implement 50 so that the cutting implement 50 can be received within the channel 24 with little play or restricted movement. As shown in FIG. 3, the cutting implement 50 can then be dragged or swiped through the narrow channel 24 along the narrow path to cut precise lines that define the liner 14 shown in FIG. 4.

Although implemented as a plastic, the first layer 20 and the second layer 30 may be composed of any suitable material, such as metal, wood, carbon fiber, silicone, and/or other acceptable material used to create a pattern within a template for cutting out liners. The first layer 20 and/or second layer 30 may be comprised of a transparent material. The transparent material is sufficiently rigid to receive the sharp blade of the cutting implement 50 as it is guided along the various narrow channels 24.

FIG. 1 shows the pattern 22 for the envelope liner 14 may take various sizes and shapes depending on the size and shape of the envelope 16 (shown in FIGS. 4-5). As shown in FIG. 1, various patterns 22 for more than one envelope liner 14 may be positioned side-by-side to maximize the number of envelop liners 14 cut by a single positioning of the envelope liner template 10 thereby maximizing the number of liners 14 created in an efficient and quick manner.

FIG. 2, for example, shows a first layer 20 having three patterns 22 positioned side-by-side to cut out three envelope liners 14 of substantially the same size from a decorative sheet 12. Each of the narrow channels 24 resemble mini houses with a peaked roof 24a connected to side walls 24b and a base 24c. The base 24c has an interrupted narrow channel that can be completely cut after the first layer 20 has been shifted from its initial cutting position, or once the first layer 20 is lifted away from the second layer 30. The connected portion of the lower interrupted channel 24c keeps the pattern 22 attached and in position while the cutting implement 50 cuts through the sheet 12 during the cutting stage shown in FIG. 3.

In FIG. 4-5, once the various patterns 22 for the liners 14 have been cut from the decorative sheet 12 to form the liners 14, a liner 14 may be installed within the envelope 16 and secured thereto. Any suitable adhesive may be used to secure the liner 14 to the envelope 16. Since numerous liners 14 may be cut by the cutting implement 50 at a time with the first layer 20 of the envelope liner template 10 positioned over the second layer 30, many decorative envelopes 14 may be created with the various liners 14 in a quick and efficient manner at one time. The added liner 14 is aesthetically pleasing and adds weight to the envelope 16 giving enhancing the perceived quality of the envelope.

The cutting implement 50 can be a standard hobby blade, a craft knife, a custom manufactured blade on a swivel and/or any other suitable versatile blade. The sharp edge of the cutting implement 50 is suitable for cutting the pattern 22 through the narrow channels 24 to define a desired liner 14 shape.

As shown in FIG. 3, in position behind the first layer 20, the second layer 30 or second template panel may be a flat piece of material substantially impervious to the sharp cutting edge of the cutting implement 50 when the cutting implement 50 cuts through the narrow channels 24 and the decorative sheet 12 against the second layer 30 to define the liner 14. The second layer 30 serves as a cutting surface backing so that a table or surface below the second layer 30 does not sustain damage from the sharp cutting implement 40 while in use.

Referring back to FIG. 1, various types of fastener mechanisms 40 may be used to removably attach the first layer 20 to the second layer 30 in a quick and convenient manner. The advantage of being able to quickly position the first layer 20 over the second layer 30 is to be able to quickly align the decorative sheet 12 under the patterns 22 in the first layer 20 in a repetitive manner. This alignment and cutting process allows quick and efficient cutting out of various liners 14 from the decorative sheet 12 at a time. It is to be understood that the fastening mechanism 40 may be embodied as a variety of different attachment connections.

A magnetic fastener 70 may be embodied as the fastening mechanism 40 that couples the first layer 20 to the second layer 30. Referring back to FIG. 1, the magnetic fastener 70 may include a pair of magnets 72, or a magnet 72 and a ferromagnetic material 74. Various magnets 72 and/or ferromagnetic materials 74 can be positioned on the first layer 20 and/or the second layer 30 to create a strong magnetic securing force positioning the first layer 20 over the second layer 30. A secure hold between the first layer 20 and the second layer 30 maintains a tight secure hold on the decorative sheet 12 during the cutting process. The benefit of the secure hold prevents the sheet 12 from sliding or shifting when the liner 14 is cut from the pattern 22 during the cutting action such as shown in FIG. 3. Likewise, after the liners 14 have been cut from the decorative sheet 12, the first layer 20 and the second layer 30 may be removed from each other very quickly by breaking the magnetic attractive force securing the first layer 20 to the second layer 30.

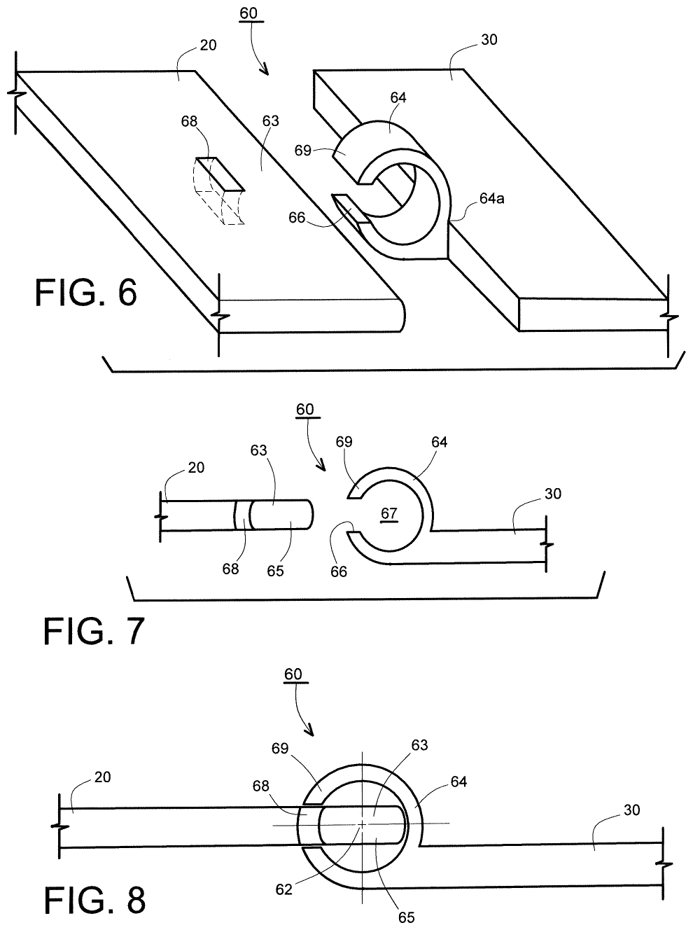

FIGS. 6-11 illustrates a hinge 60 connection that may be integrated as the fastening mechanism 40 to connect the first layer 20 to the second layer 30. The hinge 60 allows the first layer 20 to pivot relative to the second layer 30 along a pivot axis 62 (FIG. 8) for various purposes.

In particular, FIGS. 6-8 shows the hinge connection 60 having a first connection 63 and a second connection 64. The first connection 63 is disposed on the first layer 20 and is a male connection that inserts into the second connection 64 disposed on the second layer 30.

As shown in FIGS. 7-8, a key 65 in the first layer 20 is aligned with (FIG. 7) and inserted into the slot 66 in the second connection 64 and pushed all the way in until the key 65 is placed completely within an opening 67 in the second connection 64 as shown in FIG. 8. This is a first open position where the first layer 20 and the second layer 30 are free to be engaged and disengaged with each other. In this first open position, an aperture 68 is aligned with a circular arm 69 in the second connection 64.

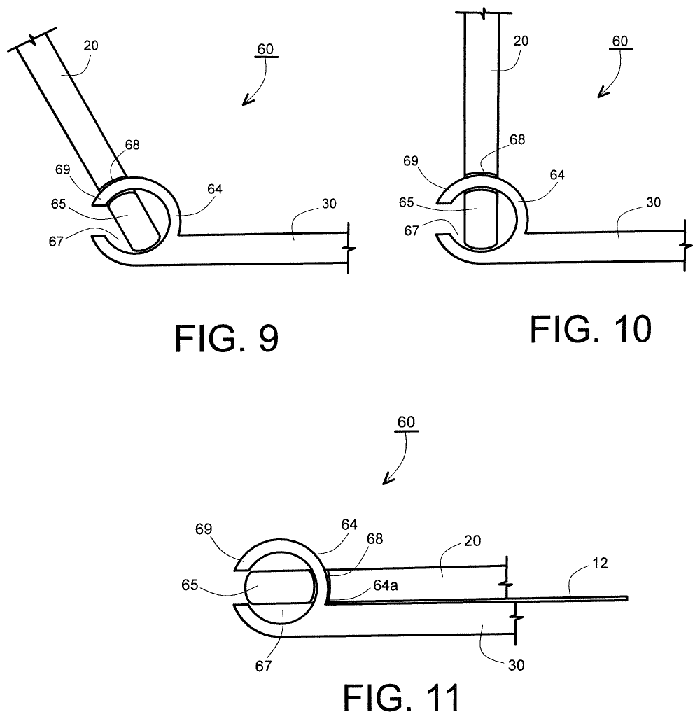

FIGS. 9-11 illustrate the in-use application in which the first layer 20 is rotated clockwise within the opening 67 in the second connection 64. As the key 65 begins its rotation (FIG. 9), the key 65 of the first layer 20 is interlocked with the circular arm 69 of the second layer 30. As the key 65 continues to be rotated, the circular arm 69 continues to feed through the aperture 68 in the first layer 20 as shown in mid-rotation in FIG. 10.

FIG. 11 illustrates the first layer 20 lying against the second layer 30 over the decorative sheet 12. This is a second interlocked position where the first layer 20 is secured in positioned over the second layer 30 by a fastener mechanism 40.

When the first layer 20 is initially rotated from the first open position shown in FIG. 9, the aperture 68 in the first connection 63 slides over the circular arm 69 in the second connection 64. Once the circular arm 69 slides through the aperture 68, the first layer 20 and the second layer 30 will be effectively interlocked with one another. Once a disconnection between the first layer 20 and the second layer 30 is desired, the first layer 20 must be rotated counterclockwise into the first open position shown in FIG. 8 so that the key 65 in the first layer 20 can be disconnected from the circular arm 69 in the second layer 30 and slid back away from the second layer 30 through the slot 66 (as shown in FIG. 7).

Likewise, the quick disconnect and connect capability of the hinge 60 composed of the first connection 63 and the second connection 64 on the first layer 20 and the second layer 30 respectively, allows for the quick cutting of numerous liners 14 and the quick and efficient changing out of the various first 20 and second layer 20 templates.

As shown in FIGS. 6 and 11, an edge 64a of the second connection 64 can act as a straight edge boundary guide for receiving and aligning the decorative sheet 12. Accordingly, insertion and alignment of the decorative sheet 12 under the various patterns 22 on the second layer 20 will be much easier and quicker to facilitate. An advantage of the hinge 60 connection is that the hinge 60 may be designed to quickly connect and disconnect in order to flip the first layer 20 and the second layer 30 with ease to cut additional liners 14 through repositioned patterns 22.

Alternatively, any suitable fastening and/or attachment fastener mechanism 40 can be used to secure the first layer 20 to the second layer 30 over the liner, such as for example, a hook and loop fastener, a snap fastener, a dovetail attachment and/or any other suitable fastener mechanism.

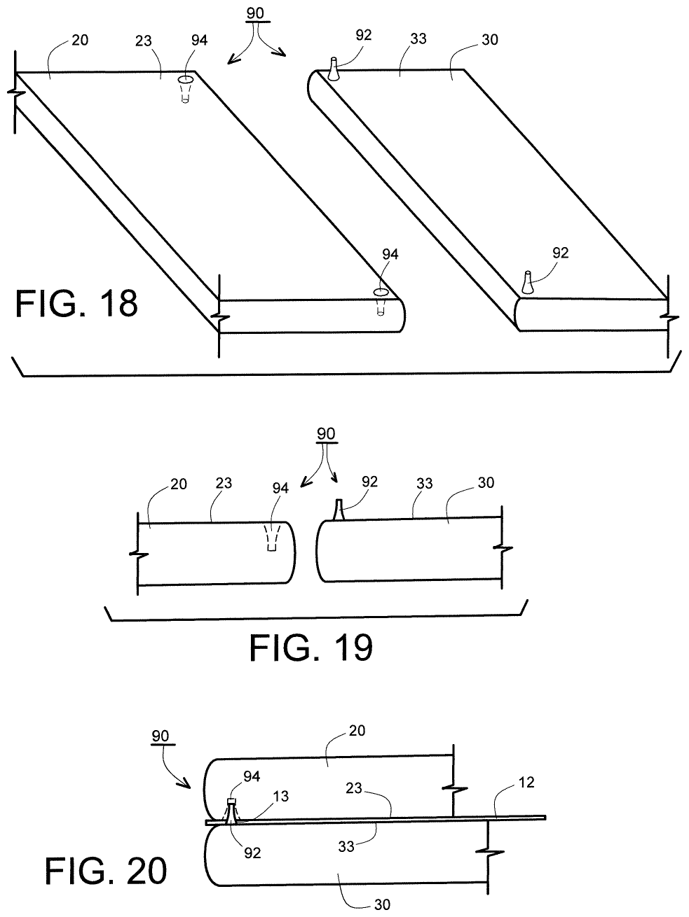

For example, FIGS. 18-19 illustrates a projection alignment 90 mechanism that may be integrated as the fastening mechanism 40 to connect the first layer 20 to the second layer 30. FIG. 18 shows projections 92 on the second layer 30 and cavities 94 on the first layer 20. It is to be understood that the projections 92 may alternatively be positioned on the first layer 20 and the cavities 94 may be positioned on second layer 30. Although shown exaggerated in size for clarity, the projections 92 and the cavities 94 may be provided in a variety of different sizes, lengths, and depths according to this subject disclosure.

The projections 92 extend outward a predetermined distance from a surface 33 of the second layer 30, and the cavities 94 extend inward a predetermined depth into a surface 23 of the first layer 20. As shown in FIG. 20, with the first 20 rotated and placed over the second layer 30, the outward predetermined distance of the projections 92 correspond to the inward depth of the cavities 94 in a mating fashion so that the first layer 20 and the second layer 30 may sit flush against the decorative sheet 12 during use.

As shown in use in FIG. 20, the projection 94 is aligned with the cavity 94 and pierces through the decorative sheet 12 into the cavity 94. When the pair of projections 92 aligned with the cavities 94 pierce a hole 13 through the decorative sheet 12, the decorative sheet 12 is forcibly secured in position and will not shift around between the first layer 20 and the second layer 30. In this manner, when the cutting implement 50 is cut through the pattern 22 over the decorative sheet 12, the decorative sheet 12 will not move allowing clean cut edges for the envelope liner 14.

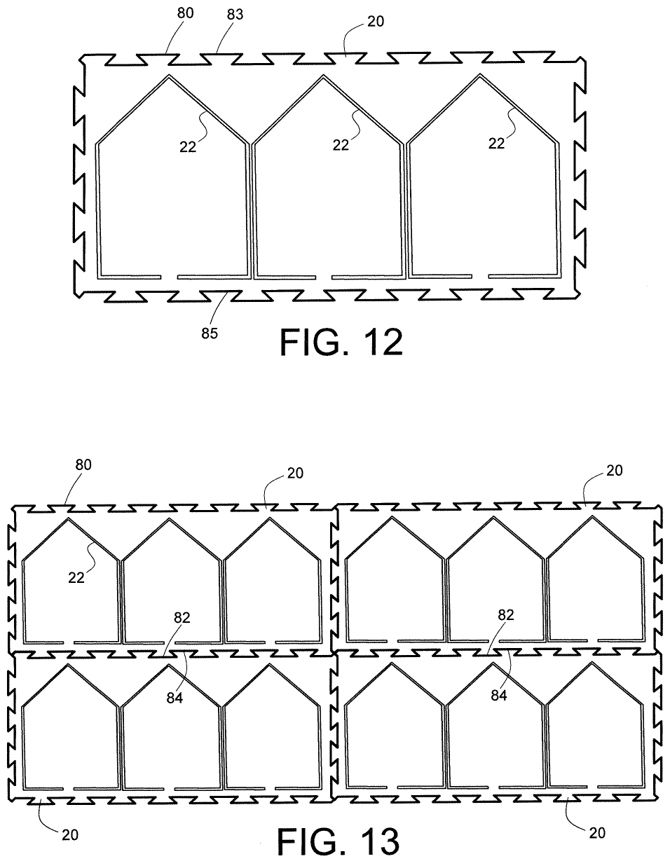

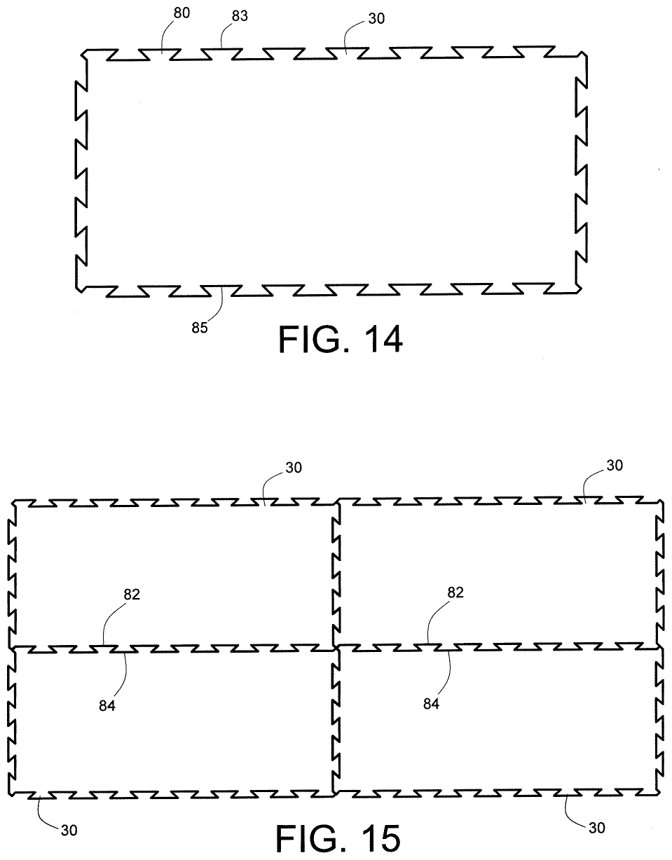

FIGS. 12-15 show that a plurality of different interconnecting mechanisms 80 can be used according to this subject disclosure. For example, FIGS. 12 and 14 shows a series of dovetail connections 80 may be constructed along the sides of the first layer 20 and the second layer 30 to position various first layers 20 adjacent to each other (shown in FIG. 13) and/or various second layers 30 adjacent to each other (shown in FIG. 15) as desired. The advantage being that the user can interlock multiple first layers 20 and/or second layers 30 together so that multiple liners 14 can be cut at once in an efficient manner.

As shown in FIG. 13, the interconnecting mechanism 80 between an adjacent pair of first layers 20 may be composed of a first portion 82 that locks into a second portion 84 in a secure manner. The first portion 82 may be a male member 83 (FIGS. 12 and 14) that interlocks with a female member 85 on the second portion 84.

Alternatively, as shown in FIG. 15, where multiple second layers 30 are desired to be interlocked, the interconnecting mechanism 80 between a pair of second layers 20 may also be composed of a first portion 82 that locks into a second portion 84 in a secure manner. Similarly, the first portion 82 may be a male member 83 that interlocks with a female member 85 on the second portion 84.

The advantage to interlocking multiple first layers 20 and/or second layers 30 together respectively is beneficial where the length and width of a large decorative sheet 12 is used, such as for example a roll of large gift-wrapping paper, where the large gift-wrapping paper is used to create multiple liners 14 at a time using the interlocking multiple layers 20, 30, shown for example in FIGS. 13 and 15. This unique interconnecting mechanism 80 will minimize wasted paper by maximizing the use of the patterns 22 over the decorative sheet 12 to be cut into numerous liners 14.

Various types of interlocking mechanisms 80 may be incorporated. For example, the envelope liner template 10 can integrate modular interlocking connections, like a jigsaw puzzle or the like, about the edges of the first layer 20 and the second layer 30. As such, various first layers 20 can be interconnected and various second layers 30 can be interconnected to construct large envelope liner templates 10 where a larger sheet 12 is used to cut multiple liners 14 at a time. That is, multiple first layers 20 can be interlocked to each other and placed over multiple second layers 30 interlocked to each other backing the multiple first layers with various patterns 22. For example, large pieces of ornamental wrapping paper can be used to create numerous liners 14 during the positioning of the first layers 20 over the second layers 30.

Likewise, the modular nature of the interlocking system can be packaged in a compact manner thereby reducing shipping costs of an oversized unitary templates in a large and cumbersome package.

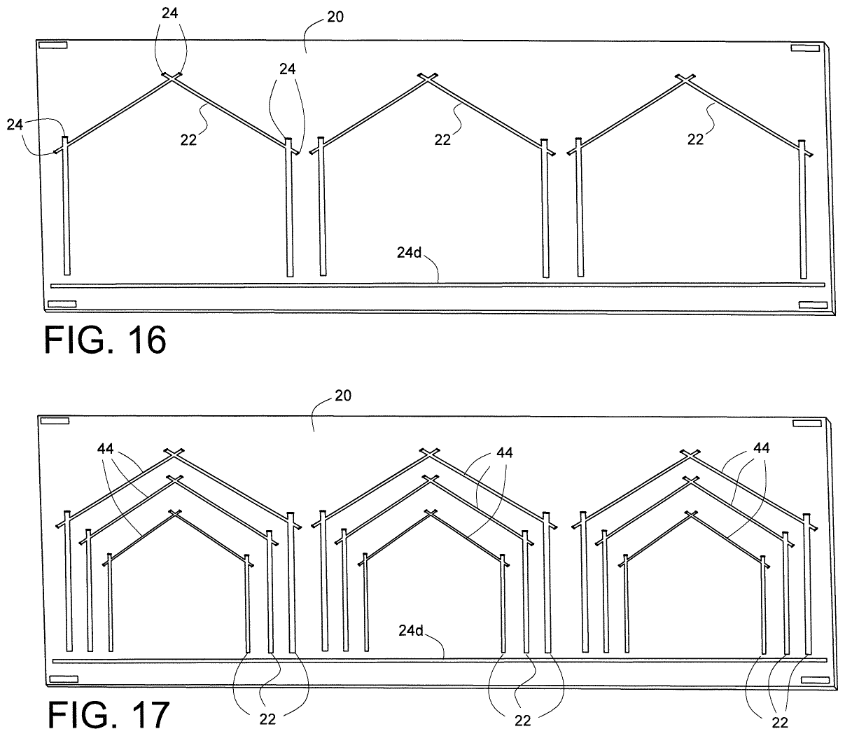

FIG. 16 illustrates another exemplary embodiment of various patterns 22 having narrow overlapping channels 24. The advantage of this construction is that less finite precise control is necessary when manipulating the cutting implement 50 through the channels 24. The user can simply cut passed an intersection defining an edge or corner of the liner 14 with ease. Less hand and eye coordination are required by the user employing this type of overlapping pattern 22 thereby allowing the user to cut out more liners 14 in a shorter period of time and in an efficient manner and while minimizing waste. The lower base line 24d channel is shown as a single uninterrupted channel. The single uninterrupted base line 24c channel at the bottom of the patterns 22 in the first layer 20 allows the user to cut various liners 14 from the patterns 22 at one time.

FIG. 17 shows another exemplary embodiment of various patterns 22 nested 44 within each other on the first layer 20. The advantage of using this first layer 20 in the envelope liner template 10 is that the user can use the same template to cut different sizes of the same or different size liners 14 for different size envelopes and/or from different sixed decorative sheets, such as sized on A4, letter size, legal size, or any other sized sheet. The single base line 24c at the bottom of the first layer 20 allows the user to cut the various nested pattern 22 shapes free from the decorative sheet 12 without the need for using cumbersome and conventional scissors. Likewise, narrow overlapping channels 24 are used allowing the user to cut more liners 14 in an efficient manner. This construction requires less finite precise control when manipulating the cutting implement 50 through the channels 24 enabling the user to make more liners 14 much quicker.

Various types of material may be used to make the liner. One ideal material for envelope liners is gift wrap as it is lightweight, inexpensive, comes in a variety of colors, themes, and prints, and can usually be found in anyone's home at any time.

As employed in this specification and annexed drawings, the term “or” is intended to mean an inclusive “or” rather than an exclusive “or.” Moreover, articles “a” and “an” as used in the subject specification and annexed drawings should generally be construed to mean “one or more” unless specified otherwise or clear from context to be directed to a singular form.

What has been described above includes examples that provide advantages of the subject disclosure. It is, of course, not possible to describe every conceivable combination of components or methodologies for purposes of describing the subject disclosure, but one of ordinary skill in the art may recognize that many further combinations and permutations of the claimed subject matter are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

The illustrations and examples provided herein are for explanatory purposes and are not intended to limit the scope of the appended claims. It will be recognized by those skilled in the art that changes, or modifications may be made to the above-described embodiment without departing from the broad inventive concepts of the subject disclosure. It is understood therefore that the subject disclosure is not limited to the particular embodiment, which is described, but is intended to cover all modifications and changes within the scope and spirit of the subject disclosure.

1. An envelope liner template comprising:
a first template panel having a pattern inscribed therein;
a second template panel positioned below the first template; and
a fastener mechanism adapted to removably secure the first template panel to the second template panel to secure a sheet therebetween when a cutting implement cuts through the pattern and the sheet against the second template panel to form a liner, wherein the fastener mechanism further comprises:
a first connection attached to the first template panel; and
a second connection attached to the second template panel.

2. The envelope liner template recited in claim 1, wherein the fastener mechanism is a magnetic fastener mechanism including at least one magnet.

3. The envelope liner template recited in claim 1, wherein the fastener mechanism is a hinge that allows the first template panel to pivot relative to the second template panel.

4. The envelope liner template recited in claim 3, wherein the hinge is a quick disconnect assembly adapted to allow a blade to quickly cut numerous liners through the pattern inscribed in the first template panel, and quick changing of the first template panel by disconnecting the first connection from the second connection of the hinge, and replacing the first template panel with a different first template panel over the second template panel.

5. The envelope liner template recited in claim 1, wherein the pattern has overlapping ends.

6. The envelope liner template recited in claim 1, wherein a second pattern is arranged in a nested configuration with the first pattern.

7. The envelope liner template recited in claim 1, wherein the first template panel is a transparent rigid material.

8. The envelope liner template recited in claim 1, wherein the first template panel and a second first template pattern are positioned side-by-side and interconnected to maximize a number of the liners cut by the patterns in the template patterns.

9. The envelope liner template recited in claim 1, wherein a second first template panel is interlocked by an interconnecting mechanism disposed at adjoining edges to increase the surface area and the number of the liners cut.

10. The envelope liner template recited in claim 1, wherein a second template panels is interlocked by an interconnecting mechanism disposed at adjoining edges to increase the surface area and the number of envelope liners cut thereon.

11. The envelope liner template recited in claim 1, wherein the fastening mechanism is a first projection integrally disposed in at least one of the first template panel or the second template panel, the first projection pierces through a sheet and matingly interlocks within a cavity that is integrally disposed in at least one of the other first template panel or the second template panel, respectively.

12. An envelope liner template comprising:
a first transparent panel having a pattern inscribed therein;
a second panel positioned below the first transparent panel; and
a magnetic fastener mechanism adapted to removably secure the first transparent panel to the second panel to secure a sheet therebetween when a cutting implement cuts through the pattern and the sheet against the second panel to form a liner, wherein the magnetic fastener mechanism further comprises:
a first magnetic connection is-directly attached to the first transparent panel; and
a second magnetic connection is-directly attached to the second panel.

13. The envelope liner template recited in claim 12, wherein the first or second magnetic connection is at least one of a magnet or a ferromagnetic material.

14. (canceled)

15. The envelope liner template recited in claim 12, wherein the pattern has overlapping ends.

16. The envelope liner template recited in claim 12, wherein a second pattern is positioned side-by-side and interconnected to maximize a number of the liners cut, and wherein at least one of the patterns has a house with peak-shaped pattern and a disconnected and uninterrupted base line to cut a bottom of the pattern.

17. The envelope liner template recited in claim 12,
wherein a second first transparent panel is interlocked by a first interconnecting mechanism to the first transparent panel, wherein the first interconnecting mechanism is disposed at adjoining edges to increase the surface area and the number of the liners cut; and
wherein a second panel is interlocked by a second interconnecting mechanism to the second panel, wherein the second interconnecting mechanism is disposed at adjoining edges to increase the surface area and the number of the liners cut thereon.

18. An envelope liner template comprising:
a first transparent panel having a pattern of an envelope liner inscribed therein, the first transparent panel adapted to be secured over a sheet into which a cutting implement cuts through the pattern and through the sheet to form a liner; and
a fastener mechanism adapted to removably secure the first transparent panel to a surface to secure the sheet therebetween when the cutting implement cuts through the pattern and through the sheet against the surface to form the liner, the fastener mechanism having a first connection attached to the first template panel.

19. The envelope liner template recited in claim 18, wherein the surface is a second panel positioned below the first transparent panel, wherein the second panel has a second connection attached to the second panel.

20. The envelope liner template recited in claim 19, wherein the fastener system is a first projection on at least one of the first transparent panel or the second panel that pierces through the sheet, and a cavity disposed on at least one of the first transparent panel or second panel that matingly interlocks with the first projection.
